(19) United States
(12) Patent Application Publication
(10) Pub. No.: US 2007/0028004 A1
(43) Pub. Date: Feb. 1, 2007

(54) Method of maintaining synchronization between mobile e-mail server and client stations, system supporting the same, and mobile station therefor

(75) Inventors: Wook-Hyun Jeong, Seoul (KR); Sang-Kyung Sung, Seoul (KR); Eun-Jung Kim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/366,518

(22) Filed: Mar. 2, 2006

(30) Foreign Application Priority Data
Jul. 13, 2005 (KR) 2005-63279

(51) Int. Cl. G06F 15/16

(52) U.S. Cl. 709/248

(57) ABSTRACT

Disclosed is a system and method of directly setting priority information for maintaining synchronization between a mobile e-mail server and a plurality of client stations. The system includes: at least one client station for transmitting client station information containing priority information and transmitting event information; and a server for receiving the client station information transmitted from the client station, confirming the priority information, changing a priority setting of the client station if the confirmed priority is higher than a stored priority; and reflecting the event information according to the priority.

### PRIORITY

This application claims priority under 35 U.S.C.§ 119 to an application entitled “Method of Maintaining Synchronization Between Mobile Email Server and Client Stations, System Supporting the Same, and Mobile Station Therefor” filed in the Korean Intellectual Property Office on Jul. 13, 2005 and assigned Serial No. 2005-63279, the contents of which are incorporated herein by reference.

### BACKGROUND OF THE INVENTION

1. Field of the Invention

The present invention relates generally to a method of maintaining synchronization between a server and client stations, a system supporting the same, and a mobile station therefor.

2. Description of the Related Art

Accompanying a variety of wireless mobile communication environments, venders provide various kinds of mobile stations, and the number of mobile stations per person is increasing. Common data distributed to a plurality of mobile stations should be synchronized. Although different synchronization methods can exist depending upon the service providers, even if different synchronization methods are used, it is important in a wireless environment to not only maintain synchronization between a server and client stations, but to also reduce the amount of transmitted data.

The purpose of the synchronization maintenance is to make common data stored in a plurality of distributed mobile stations the same. In particular, in a mobile e-mail environment, synchronization between a server and client stations, i.e., synchronization maintenance, means that states of all folders and messages inside the server and client stations are matched with each other. In the description below, a folder or message state in the server and client stations is called event information.

In the mobile e-mail environment, a method of performing synchronization between server and client stations is largely divided into a polling scheme performed by a synchronization request of a mobile station's user and a pushing scheme performed by the server without any synchronization request of the mobile station's user.

According to the polling scheme, a server responds to a transmission request from an e-mail client station, and e-mail protocols used in a wired environment, the Post Office Protocol (POP3), the Internal Message Access Protocol (IMAP), and the like are compatible with this scheme. In detail, according to the polling scheme, a client station periodically asks the server whether a new e-mail exists, and if the period of time is short, it is possible to provide a quasi real-time e-mail service. However, since the client station should periodically ask the server whether a new e-mail exists, even if a new mail does not exist, the client station cannot help but periodically ask whether e-new mail exists. Thus, by continuously polling for e-mail, network resources are wasted, and therefore the polling scheme is not suitable for the wireless environment.

According to the pushing scheme replacing the polling scheme, when new e-mail arrives at a server, the server immediately transmits the new e-mail to a relevant client station before the client station asks for whether a new e-mail exists. Since wireless network resources can be more efficiently used according to the pushing scheme, the pushing scheme is suitable for an e-mail service in a wireless environment.

In the pushing scheme, synchronization maintenance methods used include a state-comparison-based synchronization method and an event-based synchronization method. The state-comparison-based synchronization method is a method of analyzing which modification is performed for any folder or message by comparing all folders and messages related between an e-mail client station and a server and then making the folders and messages the same. That is, a difference is obtained as the comparison result, and then any necessary modifications, updates, and/or deletions are performed on folders and/or messages. Alternatively, the event-based synchronization method is a method of transmitting a specific event in an e-mail client station or a server when the specific event occurs and reflecting the received event in a relevant e-mail client station or the server. Herein, an event of a mobile e-mail occurs when a state of a folder or e-mail message of an e-mail client station or a server is changed, and transmission of the event is performed to not only inform each other of the changed state but also reflect changed contents of, for example, a folder.

When synchronization maintenance is performed according to the state-comparison-based synchronization method, the efficiency of wireless network resources can dramatically decrease, and therefore it may not be desirable to use only a single synchronization method in a wireless environment. In addition, for the event-based synchronization method, a method for maintaining synchronization between a client station and a server is also required.

It is difficult to properly reflect a user's desire when a single event is processed in different client stations using a method of maintaining synchronization when sessions are reconnected between an e-mail server and the client stations. In a current mobile e-mail service, the tendency is to support a plurality of client stations. However, when different events for the same message or folder occur in a plurality of client stations, a current system just refers to an event of a lastly connected client station. Thus, there may be no method for reflecting such a user's desire that synchronization is based on a user's desired mobile station.

As described above, in the prior art, after a certain client station, which has modified, updated, or deleted a message or a folder, accesses a server and maintains synchronization, if another client station accesses the server, an event generated when the other client station accesses the server is reflected on the certain client station. Accordingly, even if a user modified, updated, or deleted a message or a folder in the certain client station, an event confliction phenomenon caused by the event performed in the other client station can occur. That is, since an event of a lastly accessed client station always has a priority in the prior art, there is no method for the user to perform synchronization based on the event performed in the certain client station.

### SUMMARY OF THE INVENTION

An object of the present invention is to substantially solve at least the above problems and/or disadvantages and to provide at least the advantages below. Accordingly, an object of the present invention is to provide a method of maintaining synchronization between a server and at least one client station using priorities to exactly reflect a user's desire in synchronization maintenance between the server and the client station, a system supporting the same, and a mobile station therefor.

According to one aspect of the present invention, there is provided a system for performing synchronization of a mobile e-mail service, the system including at least one client station for transmitting client station information containing priority information and transmitting event information; and a server for receiving the client station information transmitted from the client station, confirming the priority information, changing a priority setting of the client station if the confirmed priority is higher than a stored priority; and reflecting the event information according to the priority.

According to another aspect of the present invention, there is provided a method of performing synchronization of a mobile e-mail service, the method including the steps of: transmitting, by a client station, client station information containing priority information to a server; receiving, by the server, the client station information, confirming the priority information, and changing a priority setting of the client station if the confirmed priority is higher than a stored priority; and reflecting the event of the client station according to the changed priority.

According to further another aspect of the present invention, there is provided a client station for performing synchronization of a mobile e-mail service, the client station including: a controller for transmitting client station information containing priority information, transmitting a signal for requesting a change of the priority information when the signal is generated, and transmitting event information to a server when the event information is generated; a memory for storing the client station information and the event information; and a radio frequency (RF) unit for transmitting and receiving the client station information and the event information to and from the server.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a mobile e-mail system for performing priority-based synchronization according to a preferred embodiment of the present invention;

FIG. 2 is a block diagram of a client station for performing priority-based synchronization according to a preferred embodiment of the present invention;

FIG. 3 is a flow diagram illustrating a process of confirming priority information between a client station and a server in the first access according to a preferred embodiment of the present invention;

FIG. 4 is a flow diagram illustrating a process of confirming priority information between a client station and a server during a session maintenance duration according to a preferred embodiment of the present invention;

FIG. 5 is a flow diagram illustrating a process of confirming priority information between a client station and a server when reconnection is performed after disconnected according to a preferred embodiment of the present invention;

FIG. 6A is a flow diagram illustrating a process of confirming priority information changed due to another client station according to a preferred embodiment of the present invention;

FIG. 6B is a flowchart illustrating a process of confirming, by a client station, priority information changed due to another client station according to a preferred embodiment of the present invention;

FIG. 6C is a flowchart illustrating a process of confirming, by a server, priority information changed due to another client station according to a preferred embodiment of the present invention;

FIG. 7A is a flow diagram illustrating a process of reflecting an event based on priority information according to a preferred embodiment of the present invention; and

FIG. 7B is a flowchart illustrating a process of reflecting, by a server, events based on priority information according to a preferred embodiment of the present invention.

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

The present invention implements a function of reflecting a user's desire by directly setting a priority for maintaining synchronization between a mobile e-mail server and client stations. To do this, the present invention performs the synchronization with data of a client station having a higher priority in processing of an event for maintaining the synchronization when the user grants a priority to at least one client station. By doing this, even if a session between the server and a client station is disconnected due to an internal and/or an external cause and is thereafter reconnected, event confliction can be prevented when the event for maintaining the synchronization is processed, thereby reflecting the user's desire.

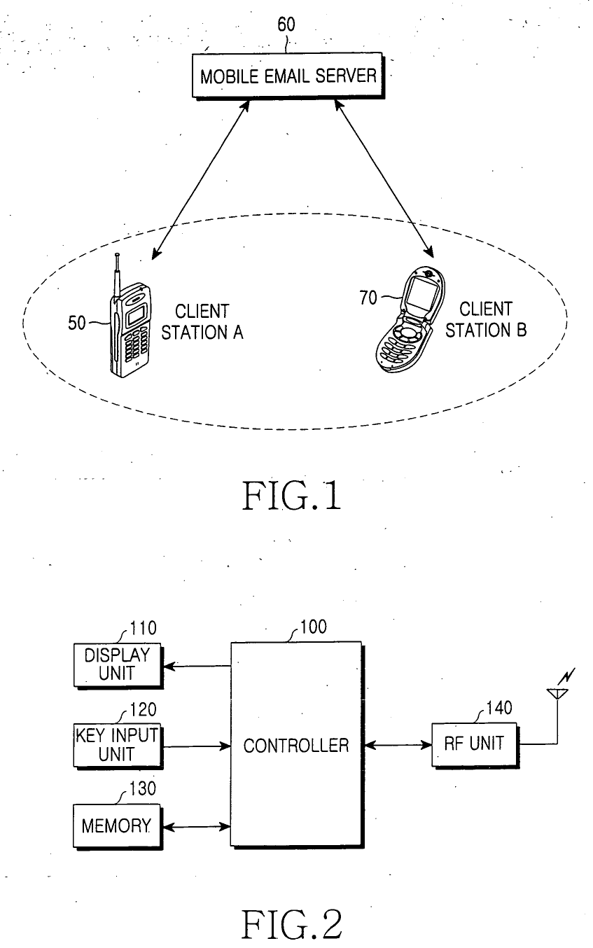

A system for providing a synchronization service to share data created or modified by a client station with different client stations will now be described with reference to FIG. 1 which illustrates a block diagram of a mobile e-mail system for performing priority-based synchronization according the present invention.

It is assumed that various client stations have a function of receiving a mobile e-mail service and a user uses at least one of the various client stations. For example, the various client stations can include the user's mobile station, laptop computer, personal digital assistant (PDA), and personal computer (PC). The use of these client stations can be determined by the user's location. For example, when mobile, the user uses the mobile phone, when in an office the user uses the PDA or laptop computer and when at home the user uses the PC. Herein, when the user reflects data created or modified using one client station, e.g., an e-mail message or an event of a folder, through an access to a server, the user can use the same information through another client station accessing the server by synchronizing the another client station with the server.

Referring to FIG. 1, according to the system configuration for data synchronization of each client station when the client station uses a mobile e-mail service, a client station “A” 50 accesses a mobile e-mail server 60 through a network interface and a client station “B” 70 also accesses the mobile e-mail server 60 through the network interface. Herein, each client station can include a cell phone, a PDA, a PC, a handheld PC, or the like.

The mobile e-mail server 60 transmits data to be shared and provides a synchronization service. In particular, the data to be shared can, for example, include various kinds of data created or modified by a user in the use of the mobile e-mail service, such as an e-mail message and/or a folder. The data transmission is achieved by transmitting data created or modified by a user of a certain client station, which has already accessed the mobile e-mail server 60, to another client station. Herein, the mobile e-mail server 60 can make registered client stations have the same data by, for instance, storing identification information, i.e., station information and user login information, of individual client stations of the same user. In addition, according to a preferred embodiment of the present invention, when receiving priority information input by a user from a certain client station, the mobile e-mail server 60 stores the priority information.

The synchronization is achieved by reflecting data modified or deleted by the same user of a different client station on the remaining client stations as well. For the data transmission and synchronization service, the mobile e-mail server 60 should perform the synchronization by receiving station information and user login information of a client station and performing authentication of the client station using the received information.

It is assumed that the client station A 50 is a station for creating or modifying data to be shared in the mobile e-mail service and the client station B 70 is a station for receiving the shared data. The user can adjust priority information using any one of the client stations 50 and 70. Herein, the priority information set when the client stations 50 and 70 were manufactured can be confirmed and changed when the client stations 50 and 70 initially access the mobile e-mail server 60, in a state where a session is established, or when the session is re-established after being disconnected. In detail, priority information of a client station is transmitted and reflected to the mobile e-mail server 60 with station information (e.g., a device ID) when the client station initially accesses the mobile e-mail server 60. In another case, the user may change priority information of a client station during a session disconnection period, and the mobile e-mail server 60 may reflect the changed priority information when the session is reconnected. In another case, the user may change priority information and transmit it to the mobile e-mail server 60 in a state where a mobile e-mail session is established. The mobile e-mail server 60 performs the synchronization by processing events received from a plurality of client stations based on the priority information and transmitting the events back to the client stations.

Components of operations of a client station having the function described above will now be described with reference to FIG. 2 which is a block diagram of a client station for performing priority-based synchronization according to the present invention. The client station includes a controller 100, a display unit 110, a key input unit 120, a memory 130, and a radio frequency (RF) unit 140.

The controller 100 controls typical phone calls, data communication, and wireless Internet accesses. In addition, the controller 100 transmits to a server client station information containing priority information, a signal for requesting a change of the priority information when the signal is generated, and event information when the event information is generated. The controller 100 receives priority change information from the server, displays the priority change information, and maintains a setting of the priority change information. In addition, the controller 100 receives event information from the server, checks the priority information, and determines whether stored event information has changed. In addition, the controller 100 requests the server to confirm current priority information of the client station, receives confirmed priority information from the server, and displays the priority information so that the user determines whether the received current priority information is changed.

The controller 100 controls the display unit 110 to receives and displays display data corresponding to key input data input through the key input unit 120 or display a state of a function set or operated by the user.

The key input unit 120 is a device for interfacing with the user and outputs key input data unique to each key when the key is pressed. The key input data output from the key input unit 120 is transmitted to the controller 100, a pressed key is detected based on the key input data. As a result of the detection, the controller 100 performs a relevant operation.

The memory 130 stores information regarding all functions of the client station and data related to the mobile e-mail service. In detail, the memory 130 stores user's login information and station information for client identification and priority information set by the user or transmitted from the server.

The controller 100 controls the RF unit 140 to transmit/receive an RF signal to/from a base transceiver station (BTS) through an antenna ANT.

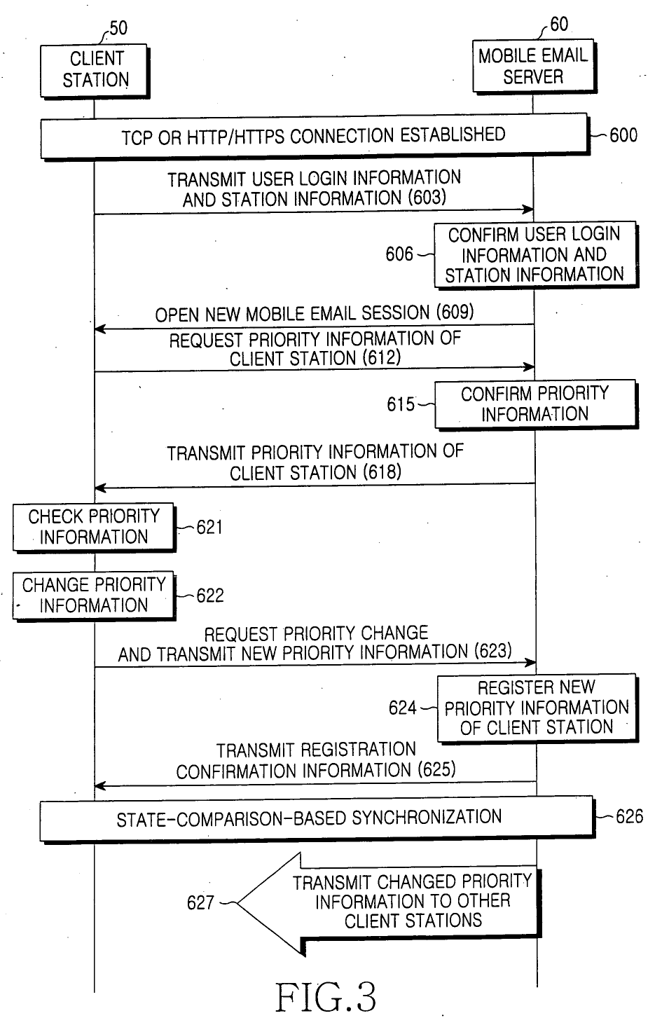

A process of confirming and registering priority information when a client station initially accesses a mobile e-mail server and a session is established between the client station and the server will now be described with reference to FIG. 3 which is a signaling diagram illustrating a process of confirming priority information between the client station 50 and the mobile e-mail server 60 in the first access according to the present invention.

Referring to FIG. 3, when the client station 50 initially accesses the mobile e-mail server 60, a TCP (Transmission Control Protocol) or HTTP/HTTPS (Hyper-Text Transfer Protocol) connection is established between the client station 50 and the mobile e-mail server 60 in step 600. In step 603, the client station 50 transmits user login and station information to the mobile e-mail server 60 for identification and authentication of the client station 50. In detail, this information can include a login name, a phone number, a domain name, and a password. This information can be transmitted in the following format: logname, “#”, “P”, phone number, “@”, domain name, and password. For example, when the login name is “joe”, the phone number is “011-xxx-xxxx”, and the password is “123456”, the information transmitted to the mobile e-mail server 60 can be represented as “joe#P011xxxxxxx123456”. In another case, when the domain name is “yyy.com”, the user/login and station information can be represented as “joe#P011xxxxxxx@yyy.com 123456”.

When the user login and station information having the format described above is transmitted to the mobile e-mail server 60, the mobile e-mail server 60 performs an authentication process for determining whether the client station 50 is authorized based on the information in step 606, and if the client station 50 is authorized, the mobile e-mail server 60 opens a new mobile e-mail session with the client station 50 in step 609. By doing this, the new mobile e-mail session is opened between the client station 50 and the mobile e-mail server 60.

Since priority information set in a manufacturing process can be changed by the user, the client station 50 needs to confirm the priority information for maintaining synchronization with the mobile e-mail server 60 every time a mobile e-mail session is opened. In particular, if the user further possesses at least one client station, since the user can change the priority information using any one client station, the priority information stored in the client station 50 may be changed. Thus, after the new mobile e-mail session is opened, the client station 50 requests the mobile e-mail server 60 to confirm the priority information of the client station 50 in step 612. The mobile e-mail server 60 confirms the priority information of the client station 50 in response to this in step 615 and transmits the confirmed priority information to the client station 50 in step 618.

The client station 50 checks the received priority information in step 621 and informs the user of the received priority information. If the user commands the client station 50 to change the priority information, the client station 50 changes the priority information in step 622. That is, the user can input new priority information. Herein, if the user does not want to change the priority information currently used in the client station 50 after the client station 50 informs the user of the priority information transmitted from the mobile e-mail server 60 for the user's convenience, the state-comparison-based synchronization is performed.

If the new priority information is input by the user, in step 623, the client station 50 requests the mobile e-mail server 60 to change the priority information thereof and simultaneously transmits the new priority information to the mobile e-mail server 60. In response to this, the mobile e-mail server 60 registers the new priority information of the client station 50 in step 624. Then the mobile e-mail server 60 adjusts and registers priority information of other client stations in the new order based on the new priority information. The mobile e-mail server 60 transmits registration confirmation information to the client station 50 in step 625. In response to this, the client station 50 performs the state-comparison-based synchronization with the mobile e-mail server 60 according to an initial access in step 626. In step 627, the mobile e-mail server 60 transmits the adjusted priority information to the other client stations whose priority is lowered due to the registration of the new priority information.

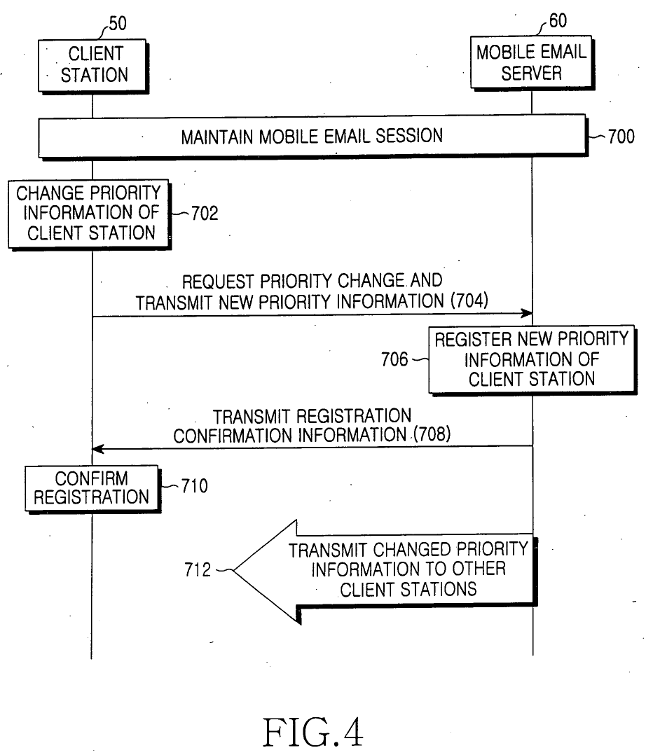

While the process of changing priority information when a client station initially accesses a server has been described, a process of changing priority information in a state where a mobile e-mail session is maintained will now be described with reference to FIG. 4 which is a flow diagram illustrating a process of confirming priority information between the client station 50 and the mobile e-mail server 60 during a session maintenance duration according to the present invention.

Referring to FIG. 4, a mobile e-mail session is maintained between the client station 50 and the mobile e-mail server 60 in step 700. Herein, the user can change priority information while using a mobile e-mail service. Thus, when the user requests the client station 50 to change priority information, the client station 50 changes priority information thereof to the priority information input by the user in step 702. In step 704, the client station 50 requests the mobile e-mail server 60 to change the priority information thereof and simultaneously transmits the new priority information input by the user to the mobile e-mail server 60.

In response to this, in step 706, the mobile e-mail server 60 registers the new priority information of client stations using the received priority information and adjusts and registers priority information of other client stations based on the new priority information. The mobile e-mail server 60 transmits registration confirmation information to the client station 50 in step 708. In response to this, the client station 50 can check whether the registration is achieved in step 710. In step 712, the mobile e-mail server 60 sequentially transmits the adjusted priority information to the other client stations whose priority is lowered due to the registration of the new priority information, thereby sharing the same priority information with all client stations currently connected and maintaining synchronization.

A process of transmitting and registering priority information when a reconnection is performed after a disconnection is the same as the process in the initial connection. Thus, client stations and a mobile e-mail server are implemented to exchange priority information after a mobile e-mail session is opened in order to maintain synchronization of the priority information. Herein, while only a case where a client station requests a server to confirm priority information thereof when a mobile e-mail session is opened in an initial connection or after reconnection is performed after disconnection has been described, the timing for setting priority information and the exchange of the priority information can be achieved in various manners.

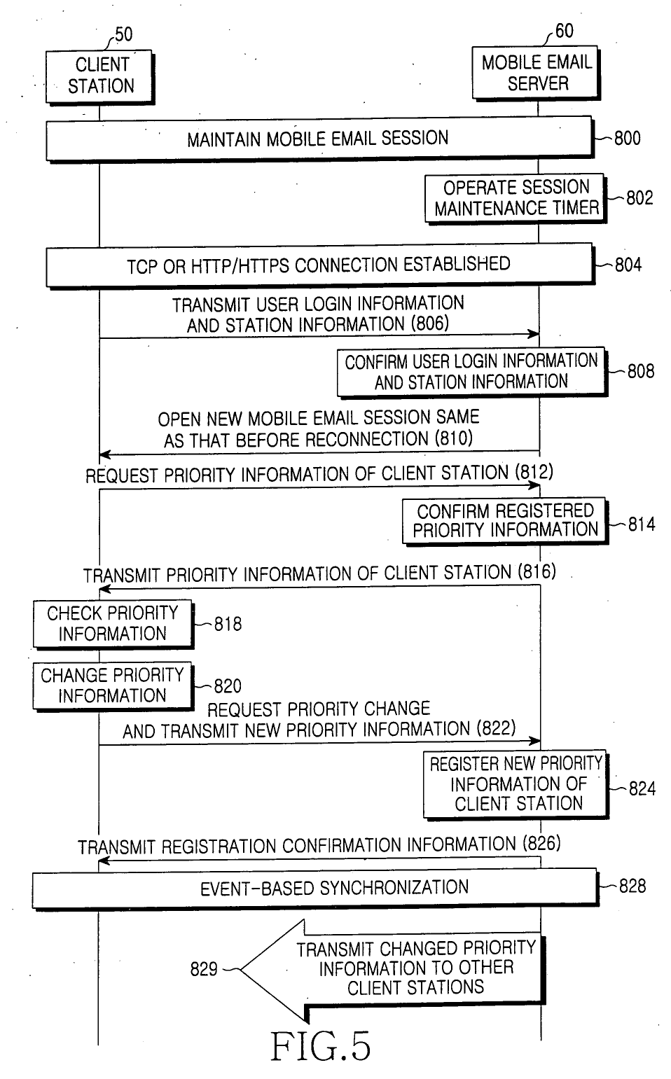

A process of confirming priority information when a reconnection is performed after a disconnection will now be described with reference to FIG. 5 which is a flow diagram illustrating a process of confirming priority information between a client station and a server when a reconnection is performed after disconnection according to the present invention.

In step 800, when a mobile e-mail session is opened between a client station 50 and a server 60 and then in a state where the session is established, the server 60 operates a timer for maintaining the mobile e-mail session in step 802. Steps 804 to 808 in FIG. 5 are the same as procedures in FIG. 3.

When the same mobile e-mail session as that before reconnection in step 810 is opened through the above-described procedures, the client station 50 requests the mobile e-mail server 60 to confirm the priority information of the client station 50 in step 812. The mobile e-mail server 60 confirms registered priority information in response to this in step 814 and transmits the confirmed priority information to the client station 50 in step 816. The client station 50 checks the received priority information in step 818 and displays the received priority information on a screen so that the user can change the priority information. If the priority information is changed by the user, the client station 50 changes the current priority information to the priority information input by the user in step 820. In step 822, the client station 50 requests the mobile e-mail server 60 to change the priority information thereof and simultaneously transmits the new priority information input by the user to the mobile e-mail server 60. In response to this, the mobile e-mail server 60 registers the new priority information of the client station 50 in step 824. Then the mobile e-mail server 60 adjusts and registers priority information of other client stations based on the new priority information. The mobile e-mail server 60 transmits registration confirmation information for informing that the new priority information transmitted from the client station 50 has been confirmed to the client station 50 in step 826. The event-based synchronization is performed between the client station 50 and the mobile e-mail server 60 by receiving the registration confirmation information. In step 829, the mobile e-mail server 60 transmits the adjusted priority information to the other client stations whose priority is changed due to the registration of the new priority information.

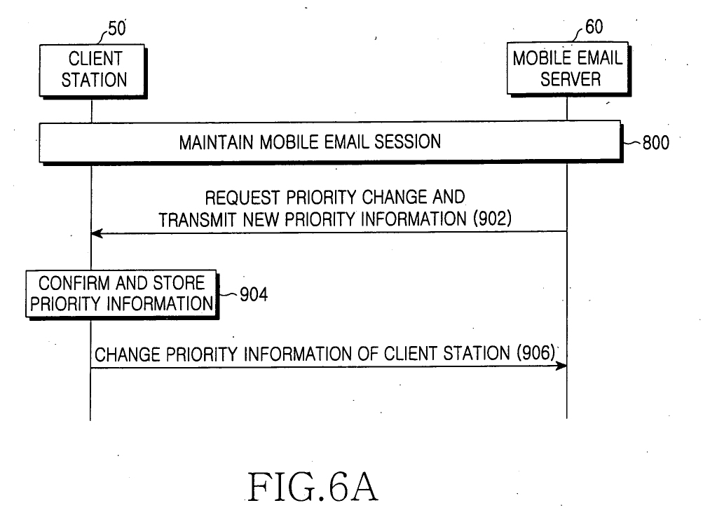

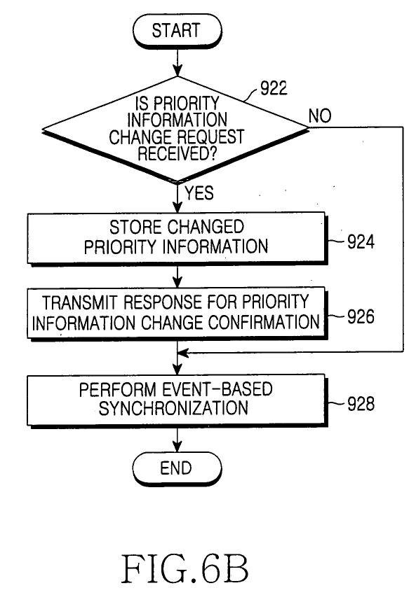

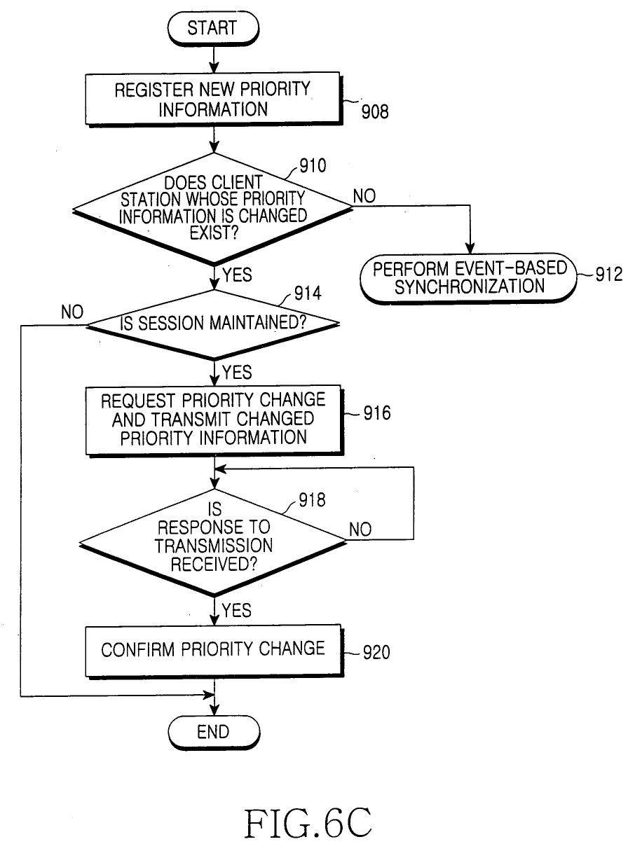

While the process of changing priority information based on a client station changing the priority information has been described, a process of changing priority information based on a client station receiving the changed priority information will now be described with reference to FIG. 6A which is a flow diagram illustrating a process of confirming priority information changed due to another client station according to the present invention.

Referring to FIG. 6A, synchronization is maintained between the client station 50 and the mobile e-mail server 60 through a session connection in step 800. Thereafter, if priority information is changed by a certain client station, the mobile e-mail server 60 transmits a priority information change request and new priority information in step 902. In other words, the mobile e-mail server 60 transmits the priority information change request for requesting the other client stations to change priority information therein to the other client stations and simultaneously transmits new priority information to the other client stations. In step 904, the client station 50 confirms and stores priority information thereof. In step 906, the client station 50 transmits priority information change confirmation information for informing that the client station 50 has confirmed the new priority information to the mobile e-mail server 60.

To describe the above in more detail, operations performed in each of the client station 50 and the mobile e-mail server 60 will now be described.

An operation performed in the client station 50 will now be described with reference to FIG. 6B. In step 922, the client station 50 determines whether a priority information change request is received from the mobile e-mail server 60. As a result of the determination, if a priority information change request is received, the client station 50 stores changed priority information in step 924 and transmits a response for informing that the priority information has been changed to the mobile e-mail server 60 in step 926. The client station 50 performs the event-based synchronization in step 928. Likewise, when priority information of other client stations is changed due to a certain client station during a session maintenance period, the server 60 transmits the changed priority information to the other client stations so that the other client stations can confirm and store the changed priority information. Thus, in the mobile e-mail service supporting multi client stations, it is important to maintain synchronization of priority information between a plurality of client stations.

An operation performed in the mobile e-mail server 60 will now be described with reference to FIG. 6C. The mobile e-mail server 60 registers new priority information in step 908. Herein, the priority information registered in the mobile e-mail server 60 can be edited by the user. Thus, the mobile e-mail server 60 searches whether a client station whose priority information is changed by the user exists in step 910. As a result of the search, if there exists no client station whose priority information is changed, the mobile e-mail server 60 performs the event-based synchronization in step 912. If there exists a client station whose priority information is changed, the mobile e-mail server 60 determines whether a mobile e-mail session is maintained in step 914. As a result of the determination of step 914, if the mobile e-mail session is maintained, the mobile e-mail server 60 requests relevant client stations to change priority information and simultaneously transmits the changed priority information in step 916. In step 918, the mobile e-mail server 60 determines whether responses according to the transmission, i.e., priority information confirmation messages, are received from the relevant client stations. If the confirmation messages are received in step 918, the mobile e-mail server 60 can acknowledge that the priority information of each client station is normally changed by confirming the change of the priority information in step 920.

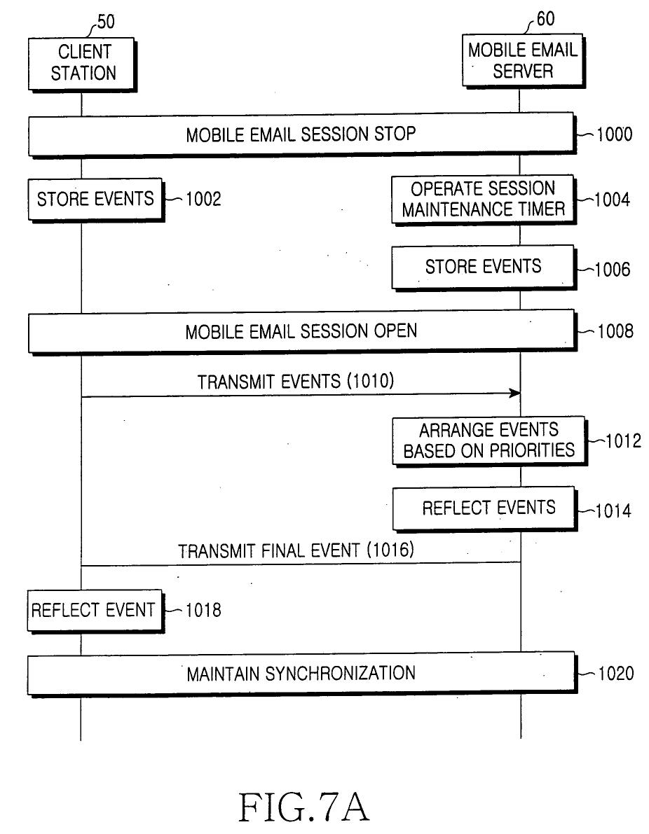

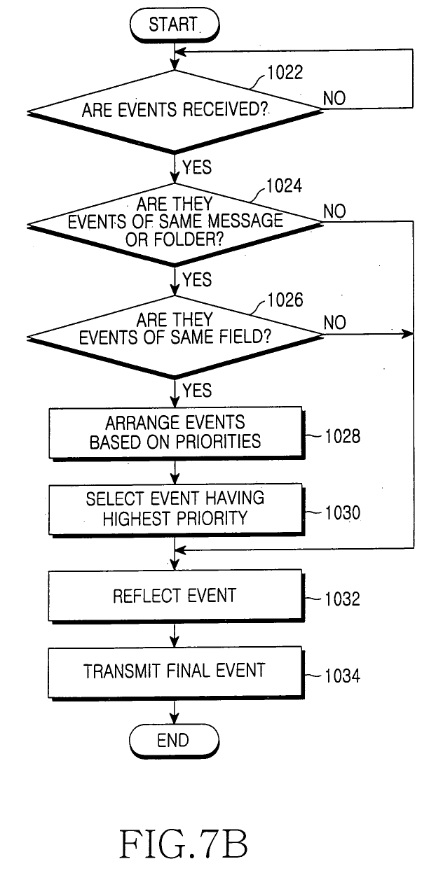

A process of reflecting an event based on priority information will now be described with reference to FIG. 7A which is a flow diagram illustrating a process of reflecting an event based on priority information according to the present invention.

Referring to FIG. 7A, a mobile e-mail session stops between the client station 50 and the mobile e-mail server 60 in step 1000. A process of reflecting an event based on priority information for maintaining synchronization when the mobile e-mail session stops will be described below. After mobile e-mail session stops, the client station 50 stores events in step 1002, and the mobile e-mail server 60 operates a timer for maintaining the mobile e-mail session in step 1004 and then stores events in step 1006. If the client station 50 accesses the mobile e-mail server 60 again within a predetermined time, i.e., the end of the session maintenance timer, the same mobile e-mail session as that before the reaccess is opened between the client station 50 and the mobile e-mail server 60 in step 1008.

Then the client station 50 transmits events stored during the session stop period to the mobile e-mail server 60 in step 1010. Accordingly, the mobile e-mail server 60 stores the received events and arranges all stored events according to priority information in step 1012 and reflects the events in step 1014. The mobile e-mail server 60 transmits an event having the highest priority based on the priority information according to the event arrangement to the client station 50 in step 1016. Then the client station 50 reflects the received event in step 1018. Accordingly, the client station 50 maintains synchronization with the mobile e-mail server 60 in step 1020.

The event arrangement operation in the mobile e-mail server 60 is illustrated in more detail in FIG. 7B which is a flowchart illustrating a process of reflecting, by the mobile e-mail server 60, events based on priority information according to a preferred embodiment of the present invention.

Referring to FIG. 7B, when events are received from the client station 50 in step 1022, the mobile e-mail server 60 determines whether the events are events of the same message or folder in step 1024. This procedure determine what type of events of the same message or folder have been generated in a current mobile e-mail session by comparing the received events with events stored in the mobile e-mail server 60 in order to prevent an event confliction when the mobile e-mail server 60 reflects all events. If it is determined that the received events are events of the same message or folder in step 1024, the mobile e-mail server 60 determines whether the events are events of the same field in step 1026. If it is determined that events of the same field are generated, the mobile e-mail server 60 arranges the events based on priority information in step 1028. Thereafter, the mobile e-mail server 60 selects an event having the highest priority in step 1030, and reflects the event in step 1032. The mobile e-mail server 60 performs synchronization by transmitting the final event reflected therein to client stations in step 1034.

For example, when client stations having different priorities change a message folder name differently and open a mobile e-mail session by accessing the mobile e-mail server 60 again (after an initial access), the mobile e-mail server 60 checks which folders received events are generated. By doing this, the mobile e-mail server 60 can determine that a change is made in a name field of a folder by the user. Likewise, if different events are generated in the same filed of the same object, such as an e-mail message or a folder, in a state where the session stops, an event confliction occurs when the client stations access the mobile e-mail server 60 again. Thus, to prevent this event confliction, the mobile e-mail server 60 arranges the received events based on priority information and defines an event generated in a client station having the highest priority as an event having the highest priority. When the mobile e-mail server 60 reflects the event having the highest priority, the reflected final event is transmitted to the client stations, thereby maintaining synchronization.

As described above, cases where an event is reflected when different client stations changed an e-mail folder name may variously exist as illustrated in Table 1. Herein, it is assumed that the priority of a client station C1 is higher than that of a client station C2.

TABLE 1

| | | Mobile | | |
|---|---|---|---|---|
| | Client | e-mail | Client | |
| State | C1 | server | C2 | Remark |
| C1: connected | A | A | A | Synchronization is achieved with a folder |
| C2: connected | | | | name A. |
| | A | A | C | An event is generated when A is changed to |
| | | | | C in C2. |
| | A | C | C | The server changes A to C by |
| | | | | receiving/reflecting the event from C2. |
| | C | C | C | C1 changes A to C by receiving/reflecting |
| | | | | the event from the server. Synchronization is |
| | | | | achieved. |
| C1: connected | A | A | A | Synchronization is achieved with a folder |
| C2: connected | | | | name A. |
| | B | A | A | An event is generated when A is changed to |
| | | | | B in C1. |
| | B | B | A | The server changes A to B by |
| | | | | receiving/reflecting the event from C1. |
| | B | B | B | C2 changes A to B by receiving/reflecting |
| | | | | the event from the server. Synchronization is |
| | | | | achieved. |
| C1: | A | A | A | Synchronization is achieved with a folder |
| reconnected | | | | name A. |
| after | B | A | C | Events are generated when C1 changes A to |
| disconnected | | | | B and C2 changes A to C during a session |
| C2: | | | | stop period. |
| reconnected | B | A | C | C2 is reconnected to the server. |
| after | B | C | C | The server changes A to C by |
| disconnected | | | | receiving/reflecting the event from C2. |
| | B | C | C | C1 is reconnected to the server. |
| | B | B | C | The server receives the event from C1 and |
| | | | | changes C to B by reflecting the event of C1 |
| | | | | since the priority of C1 is higher. |
| | B | B | B | C2 changes C to B by receiving/reflecting |
| | | | | the event from the server. Synchronization is |
| | | | | achieved. |
| C1: | A | A | A | Synchronization is achieved with a folder |
| reconnected | | | | name A. |
| after | B | A | C | Events are generated when C1 changes A to |
| disconnected | | | | B and C2 changes A to C during a session |
| C2: | | | | stop period. |
| reconnected | B | A | C | C1 is reconnected to the server. |
| after | B | B | C | The server changes A to B by |
| disconnected | | | | receiving/reflecting the event from C1. |
| | B | B | C | C2 is reconnected to the server. |
| | B | B | B | C2 receives the event from the server and |
| | | | | changes C to B by reflecting the event of C1 |
| | | | | since the priority of C1 is higher. |
| | | | | Synchronization is achieved. |
| C1: | A | A | A | Synchronization is achieved with a folder |
| reconnected | | | | name A. |
| after | B | A | C | Events are generated when C1 changes A to |
| disconnected | | | | B during a session stop period and C2 |
| C2: connected | | | | changes A to C during a session connection |
| | | | | period. |
| | B | C | C | The server changes A to C by |
| | | | | receiving/reflecting the event from C2. |
| | B | C | C | C1 is reconnected to the server. |
| | B | B | C | The server receives the event from C1 and |
| | | | | changes C to B by reflecting the event of C1 |
| | | | | since the priority of C1 is higher. |
| | B | B | B | C2 changes C to B by receiving/reflecting |
| | | | | the event from the server. Synchronization is |
| | | | | achieved. |
| C1: connected | A | A | A | Synchronization is achieved with a folder |
| C2: | | | | name A. |
| reconnected | B | A | C | Events are generated when C1 changes A to |
| after | | | | B during a session connection period and C2 |
| disconnected | | | | changes A to C during a session stop period. |
| | B | B | C | The server changes A to B by |
| | | | | receiving/reflecting the event from C1. |
| | B | B | C | C2 is reconnected to the server. |
| | B | B | B | C2 receives the event from the server and |
| | | | | changes C to B by reflecting the event of C1 |
| | | | | since the priority of C1 is higher. |
| | | | | Synchronization is achieved. |

For all the above-described cases, even if a plurality of client stations access the mobile e-mail server, the procedures described above can be performed based on priority information.

As described above, according to the present invention, by achieving synchronization using data of a client station whose priority defined by a user is higher, an event confliction can be prevented, and a user's desire can be correctly reflected. In addition, since the user can directly set priority information, user's convenience can be raised, and therefore a mobile e-mail service market can be activated.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A system for performing synchronization of a mobile e-mail service, the system comprising:
at least one client station for transmitting client station information including priority information and transmitting event information; and
a server for receiving the client station information transmitted from the client station, confirming the priority information, changing a priority setting of the client station if the confirmed priority information has a priority setting which is higher than a stored priority setting; and reflecting the event information according to the changed priority.

2. The system of claim 1, wherein the client station information is transmitted when at least one of the following events occurs: a) an initial session connection request is transmitted by the at least one client station to the server, b) during a session connection, and c) a session reconnection is requested.

3. The system of claim 1, wherein the client station information contains at least one of station identification and user login information.

4. The system of claim 1, wherein the event information includes change of mobile e-mail service related data stored in the at least one client station.

5. The system of claim 1, wherein the event information includes change of mobile e-mail service related data stored in the server.

6. The system of claim 1, wherein the at least one client station requests a session connection from the server and receives authentication confirmation information from the server.

7. The system of claim 1, wherein the server transmits the event information reflected according to the changed priority to other client stations.

8. The system of claim 1, wherein the at least one client station transmits a current priority confirmation request to the server, receives confirmed priority information from the server, and receives information indicating whether the received current priority information is changed.

9. The system of claim 8, wherein the client station:
receives newly input priority information;
transmits the newly input priority information to the server if the newly input priority information is changed priority information; and
maintains the newly priority information by setting it as changed priority information.

10. The system of claim 9, wherein the server:
receives the changed priority information from the at least one client station; registers the changed priority information; and
transmits the changed priority information to other client stations.

11. A method of performing synchronization of a mobile e-mail service, the method comprising the steps of:
transmitting, by a client station, client station information including priority information to a server;
receiving, by the server, the client station information, confirming the priority information, and changing a priority setting of the client station if the confirmed priority information has a priority setting which is higher than a stored priority setting; and
reflecting the event of the client station according to the changed priority setting.

12. The method of claim 11, wherein the client station information is transmitted when at least one of the following events occur: the a) an initial session connection request is transmitted by the at least one client station to the server, b) during a session connection, and c) when a session reconnection is requested.

13. The method of claim 11, wherein the client station information includes at least one of station identification and user login information.

14. The method of claim 11, wherein the event information change of mobile e-mail service related data stored in the client station.

15. The method of claim 11, wherein the event information includes change of mobile e-mail service related data stored in the server.

16. The method of claim 11, further comprising the steps of:
requesting, by the at least one client station, the server for a session connection; and
receiving, by the at least one client station authentication confirmation information from the server.

17. The method of claim 11, further comprising the step of transmitting, by the server, the event information reflected according to the changed priority setting to other client stations.

18. The method of claim 11, further comprising the steps of:
transmitting, by the at least one client station, a current priority confirmation request to the server; and receiving confirmed priority information from the server and receiving information indicating whether the received current priority information is changed priority information.

19. The method of claim 18, further comprising the steps of:
receiving, by the at least one client station, newly input priority information;
transmitting the input priority information to the server if it is changed priority information; and
maintaining the changed priority information by setting it.

20. The method of claim 19, further comprising the steps of:
receiving, by the server, the changed priority information from the at least one client station; and
registering the changed priority information and transmitting the changed priority information to other client stations.

21. A client station for performing synchronization of a mobile e-mail service, the client station comprising:
a controller for transmitting client station information containing priority information, transmitting a signal for requesting a change of the priority information when the signal is generated, and transmitting event information to a server when the event information is generated;
a memory for storing the client station information and the event information; and
a radio frequency (RF) unit for transmitting and receiving the client station information and the event information to and from the server.

22. The client station of claim 21, wherein the event information includes change of mobile e-mail service related data stored in the memory.

23. The client station of claim 21, wherein the controller receives priority change information from the server, displays the priority change information, and maintains a setting of the priority change information.

24. The client station of claim 21, wherein the controller receives event information from the server, checks priority information, and determines whether stored event information is changed.

25. The client station of claim 21, wherein the controller requests a current priority of the client station to be confirmed by the server, receives confirmed priority information from the server, and receives information indicating whether the received current priority information is changed.
